(19) United States
(12) Patent Application Publication
(10) Pub. No.: US 2023/0048334 A1
(43) Pub. Date: Feb. 16, 2023

(54) LIFE LOG MANAGEMENT DEVICE, CONTROL METHOD, AND STORAGE MEDIUM

(71) Applicant: NEC Corporation, Minato-ku, Tokyo (JP)

(72) Inventor: Kan Arai, Tokyo (JP)

(73) Assignee: NEC Corporation, Minato-ku, Tokyo (JP)

(21) Appl. No.: 17/792,868

(22) PCT Filed: Jan. 31, 2020
(86) PCT No.: PCT/JP2020/003735

§ 371 Date: Jul. 14, 2022

(51) Int. Cl. H04N 7/18; H04N 5/272

(52) U.S. Cl. CPC H04N 7/183; H04N 5/272

(57) ABSTRACT

A life log management device 1A mainly includes an image retrieval unit 31A and a display control unit 33A. The image retrieval unit 31A is configured to retrieve an objective image Iobj in which a target user is photographed from a database 22A of installation camera images generated by a camera installed in a public place. The display control unit 33A is configured to display life log information based on the objective image Iobj on a display device 7A.

### TECHNICAL FIELD

The present invention relates to a technical field of a life log management device, a control method, and a storage medium for managing a life log.

### BACKGROUND ART

A service to record a life log has been proposed. For example, Patent Literature 1 discloses a life log recording system for recording vehicle a driving operation behavior of a driver during driving a vehicle as life log data. Further, Patent Literature 2 discloses a wearable device capable of recording external images continuously captured as a life log.

### CITATION LIST

### Patent Literature

Patent Literature 1: JP 2017-059044A

Patent Literature 1: JP 2014-115457A

### SUMMARY

### Problem to be Solved

In Patent Literature 1, although it is possible to generate a life log relating to the vehicle driving operation behavior of the driver during driving a vehicle, the scope of application is limited, and there is no disclosure regarding the acquisition of a life log which comprehensively represents the daily life of a target person. Further, in Patent Literature 2, it is necessary for a user to wear the wearable device to generate the life log, so there is a burden on the user.

In view of the above-described issue, it is therefore an example object of the present disclosure to provide a life log management device, a control method, and a storage medium capable of suitably generating and presenting a life log.

### Means for Solving the Problem

In one mode of the life log management device, there is provided a life log management device including: an image retrieval unit configured to retrieve an objective image in which a target user is photographed from a database of installation camera images generated by a camera installed in a public place; and a display control unit configured to display life log information based on the objective image on a display device.

In one mode of the control method, there is provided a control method executed by a computer, the control method comprising: retrieving an objective image in which a target user is photographed from a database of installation camera images generated by a camera installed in a public place; generating life log information based on the objective image; and displaying the life log information on a display device.

In one mode of the storage medium, there is provided a storage medium storing a program executed by a computer, the program causing the computer to function as: an image retrieval unit configured to retrieve an objective image in which a target user is photographed from a database of installation camera images generated by a camera installed in a public place; an objective image generation unit configured to generate life log information based on the objective image; and a display control unit configured to display the life log information on a display device.

### Effect

An example advantage according to the present invention is to suitably generate and present life log information on a target user.

### BRIEF DESCRIPTION OF THE DRAWINGS

FIG. 1 illustrates a configuration of a life log management system according to a first example embodiment.

FIG. 2A illustrates an example of the data structure of a landscape database (DB: DataBase).

FIG. 2B illustrates an example of the data structure of the installation camera image DB.

FIG. 3A illustrates a block configuration of a life log management device.

FIG. 3B illustrates a block configuration of a user terminal.

FIG. 4 illustrates an example of a functional block of a processor of the life log management device.

FIG. 5 is a diagram showing an outline of the process executed by a subjective image generation unit.

FIG. 6 illustrates an example of a functional block of the subjective image generation unit.

FIG. 7 illustrates an example of a life log list view.

FIG. 8 illustrates an example of a life log playback view.

FIG. 9 is an example of a flowchart illustrating a processing procedure executed by the life log management device with respect to the display process of the life log list view and the life log playback view in the first example embodiment.

FIG. 10 is a functional block diagram of a processor in a modification.

FIG. 11 is a functional block diagram of a processor in a modification.

FIG. 12 illustrates the configuration of the life log management system in a modification.

FIG. 13 illustrates a schematic configuration of a life log management device according to a second example embodiment.

### EXAMPLE EMBODIMENTS

Hereinafter, an example embodiment of a life log management device, a control method, and a storage medium will be described with reference to the drawings.

### First Example Embodiment

(1) System Configuration

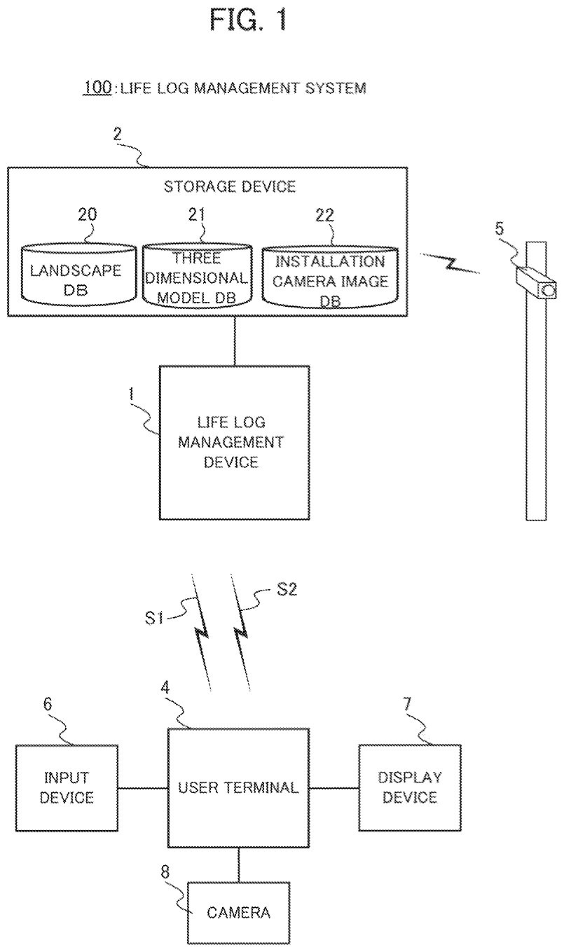

FIG. 1 shows the configuration of the life log management system 100 according to the first example embodiment. The life log management system 100 is a system for managing and presenting information (also referred to as “life log information”) on a life log. The life log management system 100 mainly includes a life log management device 1, a storage device 2, a user terminal 4, and a plurality of installation cameras 5 each provided in a public place. The term “provided in a public space” herein refers to being arranged and installed to photograph a space where a large number of unspecified people can enter and exit for no charge or for a fee, and an installation camera 5 may be provided in a place managed by a private sector (e.g., a private facility), or may be provided in a place managed by a national or local government. The installation camera 5 may also be provided in a city or may be provided in a building such as a shopping facility. The installation camera 5 is typically a security camera managed by a national or local government or private sector.

The life log management device 1 refers to the information stored in the storage device 2 and thereby generates a display control signal “S2” relating to the display in response to an input signal “S1” received from the user terminal 4, and transmits the display control signal S2 to the user terminal 4. As will be described later, the life log management device 1 generates an image (also referred to as “objective image Iobj”) representing a user of the user terminal 4 from an objective viewpoint or an image (also referred to as “subjective image Isub”) representing a view visually recognized by the user from the viewpoint of the user. Then, the life log management device 1 transmits a display control signal S2 for displaying the life log information including at least one of the objective image Iobj or the subjective image Isub to the user terminal 4.

The storage device 2 stores information necessary for the life log management device 1 to generate the display control signal S2. The storage device 2 mainly stores a landscape DB 20, a three dimensional model DB 21, and an installation camera image DB 22. The landscape DB 20 is a database in which multiple images of landscapes photographed from multiple viewpoints are recorded. The three dimensional model DB 21 is a database in which information on three dimensional models of various objects (including a person) which may exist in a landscape is stored. The installation camera image DB 22 is a database of time series images (also referred to as “installation camera images Im”) captured by the installation cameras 5. The data structure of the landscape DB 20 and the installation camera image DB 22 will be described later.

The storage device 2 may be an external storage device connected to or built in to the life log management device 1 such as a hard disk, or may be a storage medium that is detachable from the life log management device 1 such as a flash memory. The storage device 2 may be configured by one or more server devices that perform data communication with the life log management device 1. The database or the like stored in the storage device 2 may be dispersedly stored by a plurality of devices or storage media.

The user terminal 4 is a terminal used by a user who browses his/her life log. The user terminal 4 transmits an input signal S1 based on the input by the viewer to the life log management device 1 and then receives the display control signal S2, as a response, from the life log management device 1 to thereby perform a control of displaying information based on the display control signal S2. The user terminal 4, the input device 6, the display device 7, and the camera 8, is electrically connected through a wired or wireless communication.

The input device 6 is an interface that accepts the input by the user, and examples thereof include a touch panel, a button, a remote controller, and a voice input device. The input device 6 supplies the input information generated based on the user's input to the life log management device 1. The display device 7 displays information based on the display signal supplied from the life log management device 1 and examples of the display device 7 include a display such as a monitor and a head mount display, and a projector.

The camera 8 is a camera for capturing an image of the user who operates the user terminal 4, and generates a captured image of the user. Then, the camera 8 supplies the generated image to the user terminal 4.

The configuration of the life log management system 100 shown in FIG. 1 is an example, various changes may be applied to the configuration. For example, the life log management device 1 and the storage device 2 may be configured by a single device. Similarly, the user terminal 4 and at least any one of the input device 6, the display device 7, and the camera 8 may be configured by a single device. In this case, the user terminal 4 may be a tablet terminal having a built-in input device 6, a display device 7, and a camera 8. Further, the life log management device 1 may be configured by a plurality of devices. In this case, the plurality of devices constituting the life log management device 1 transmits and receives information necessary for executing the pre-allocated process among the plurality of devices.

(2) Data Structure

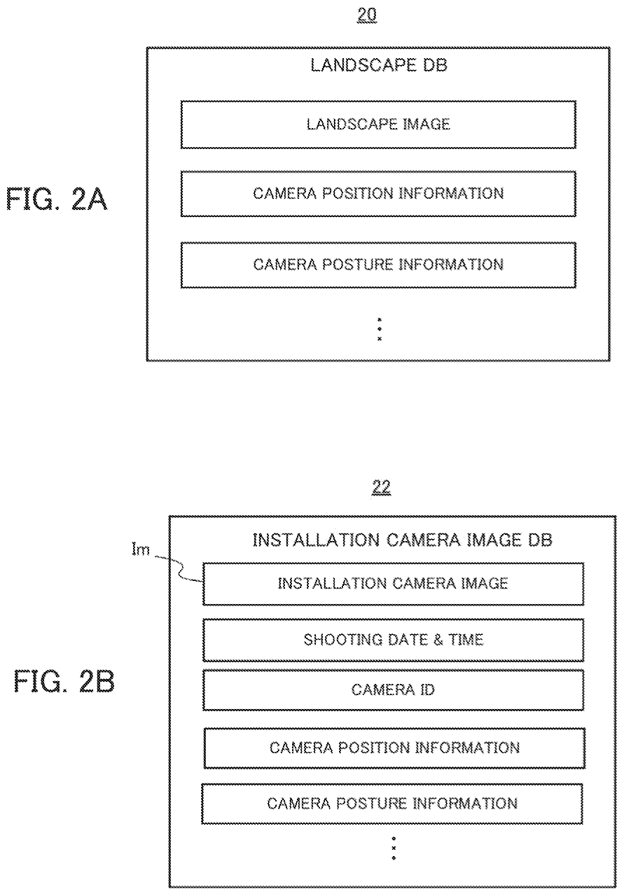

FIG. 2A shows an example of the data structure of the landscape DB 20. As shown in FIG. 2A, the landscape DB 20 is a database in which each landscape image is at least associated with camera position information and camera posture information. The “landscape image” is an image obtained by capturing a landscape in a street or downtown or the like, and may be an image captured from a camera installed in a moving vehicle or may be an image captured from a camera held by a pedestrian. If the landscape image includes an area requiring privacy consideration such as an area of a pedestrian's face and an area of nameplate, the area is subject to predetermined privacy processing. The “camera position information” is information indicating the position (i.e., the position where the camera is installed) of the camera that captures the corresponding landscape image. The camera position information indicates the absolute position (e.g., latitude, longitude and altitude). The “camera posture information” is information indicating the posture (i.e., the orientation of the camera) of the camera captured the corresponding landscape image. The camera posture information indicates the absolute posture (e.g., a combination of an azimuth angle and an elevation/depression angle) of the camera. In addition to the camera position information and the camera posture information, various metadata such as information indicating the shooting date and time, and information on the parameters (attributes) of the camera may be further associated with each landscape image.

FIG. 2B shows an example of a data structure of the installation camera image DB 22. As shown in FIG. 2B, the installation camera image DB is a database in which each installation camera image Im is at least associated with the shooting date and time, the camera ID, the camera position information, and the camera posture information. The “shooting date and time” indicates the date and time at which the corresponding installation camera image Im was generated. The “camera ID” is the identification information assigned to the installation camera 5 which generated the corresponding installation camera image Im. The “camera position information” is information indicating the absolute position (e.g., latitude, longitude and altitude) of the installation camera 5 that generated the corresponding installation camera image Im. The “camera posture information” is information indicating the absolute posture (e.g., a combination of an azimuth angle and an elevation/depression angle) of the camera captured the corresponding installation camera image Im.

It is noted that each installation camera image Im may be further associated with various metadata such as parameters (attribute) of the installation camera 5 in addition to the shooting date and time, the camera ID, the camera position information and the camera posture information. The installation camera image DB 22 may also be configured by a plurality of databases. For example, the installation camera image DB 22 includes a first database in which the installation camera image Im and the imaging date and time and the camera ID are associated, and a second database in which information (e.g., camera position information and camera posture information) relating to the installation camera 5 for each camera ID is recorded. In this case, the installation camera image DB 22 may be stored in a distributed manner by a plurality of storage devices 2.

(3) Hardware Configuration

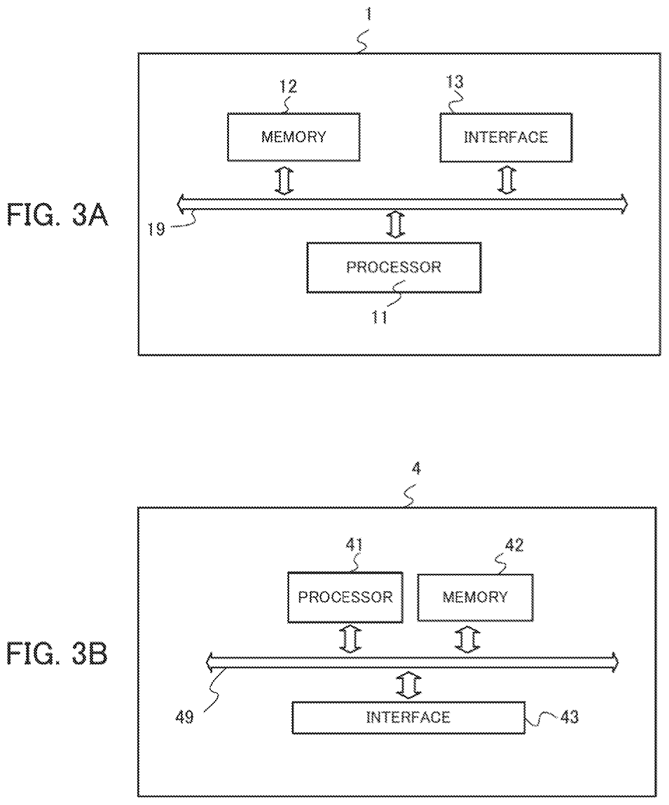

FIG. 3A shows an example of a hardware configuration of the life log management device 1. The life log management device 1 includes a processor 11, a memory 12, and an interface 13 as hardware. The processor 11, the memory 12, and the interface 13 are connected to one another via a data bus 19.

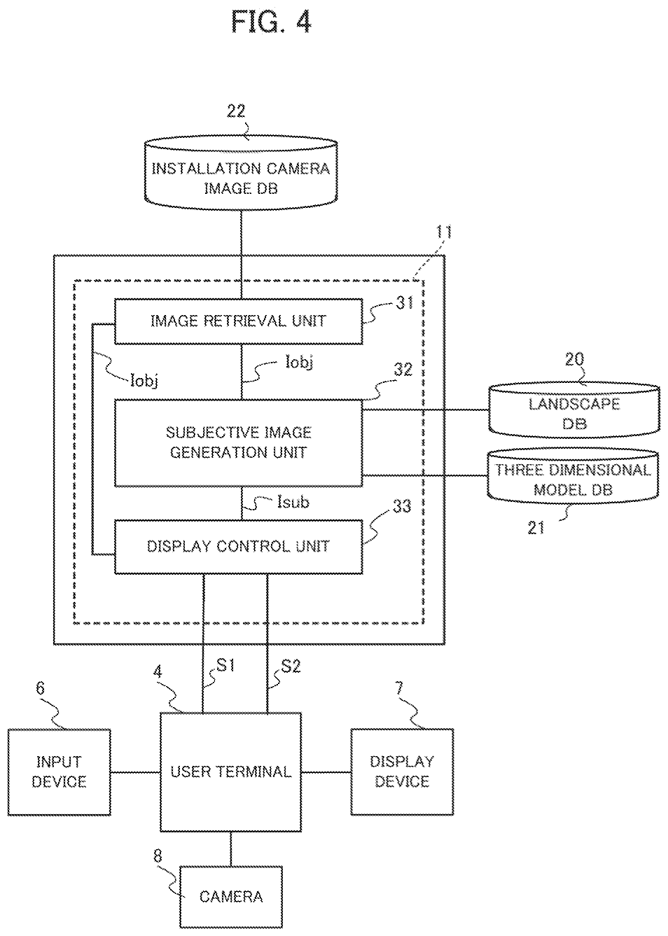

The processor 11 executes a predetermined process by executing a program stored in the memory 12. The processor 11 is one or more processors such as a CPU (Central Processing Unit) and a GPU (Graphics Processing Unit). The process executed by the processor 11 will be described in detail with reference to the functional block diagram in FIG. 4.

The memory 12 is configured by various memories such as a RAM (Random Access Memory), a ROM (Read Only Memory), and a nonvolatile memory. In addition, a program for executing a predetermined process by the life log management device 1 is stored in the memory 12. The memory 12 includes a memory used as a work memory, and temporarily stores information or the like referred to by the processor 11. Incidentally, the memory 12 may function as a storage device 2. Similarly, the storage device 2 may function as a memory 12 of the life log management device 1. The program to be executed by the life log management device 1 may be stored in a storage medium other than the memory 12.

The interface 13 is an interface for electrically connecting the life log management device 1 and other devices. For example, interface 13 includes an interface for electrically connecting the life log management device 1 to the storage device 2. For example, the interface for connecting the life log management device 1 to the storage device 2 is a communication interface such as a network adapter for wired or wireless transmission and reception of data to and from the storage device 2 under the control of the processor 11. In another example, the life log management device 1 and the storage device 2 may be connected by a cable or the like. In this case, the interface 13 includes any interface which conforms to a USB, a SATA (Serial AT Attachment) or the like for exchanging data with the storage device 2.

The configuration of the life log management device 1 is not limited to the configuration shown in FIG. 3A. For example, the life log management device 1 may be connected to or incorporate at least one of an input unit for receiving an input by a user, a display unit such as a display, or a sound output device such as a speaker. For example, the life log management device 1 may be a tablet type terminal or the like in which the input function and the output function are integrated with the main body.

FIG. 3B shows an example of a block configuration of the user terminal 4. The user terminal 4 includes, as hardware, a processor 41, a memory 42, and an interface 43. Each element of the user terminal 4 is connected to one another via a data bus 49.

The processor 41 executes a predetermined process by executing a program stored in the memory 42. The processor 41 is one or more processors such as a CPU and a GPU. The memory 42 is configured by various memories such as a RAM, a ROM, and a non-volatile memory. The memory 42 stores a program for the user terminal 4 to execute a predetermined process. The memory 42 also includes a memory that is used as a work memory and temporarily stores information to be referred to by the processor 41.

The interface 43 is an interface for electrically connecting user terminal 4 to other devices. For example, interface 43 includes an interface for electrically connecting the user terminal 4 to the input device 6, display device 7, and camera 8. For example, the interface for connecting the user terminal 4 to these external devices may be a wireless communication module such as a network adapter, or may be an insertion port of a cable for wired connection between the user terminal 4 and other devices.

The configuration of the user terminal 4 is not limited to the configuration shown in FIG. 3B. For example, the user terminal 4 may include at least one of the input device 6, the display device 7, and the camera 8 as described above. Further, the user terminal 4 may be a tablet terminal which incorporates the input device 6, the display device 7 and the camera 8.

(4) Functional Block

(4-1) Overview

FIG. 4 is an example of a functional block illustrating an overview of the processor 11 of the life log management device 1. The processor 11 of the life log management device 1 functionally includes an image retrieval unit 31, a subjective image generation unit 32, and a display control unit 33.

The image retrieval unit 31 retrieves one or more installation camera images Im in which the user (also referred to as a “target user”) of the user terminal 4 is included as a subject from the installation camera image DB 22. Then, the image retrieval unit 31 extracts the retrieved installation camera images Im from the installation camera image DB 22 and supplies the extracted installation camera images Im to the subjective image generation unit 32 as objective images Iobj. In this case, the image retrieval unit 31 supplies the camera position information and the camera posture information and the like associated with the installation camera images Im in the installation camera image DB 22 to the subjective image generation unit 32 as metadata of the objective images Iobj.

In some embodiments, the input signal S1 transmitted from the user terminal 4 to the life log management device 1 includes an image (also referred to as “authentication image”) for authentication in which the target user is photographed, and the image retrieval unit 31 may perform retrieval of the objective images Iobj based on the authentication image. In this case, the image retrieval unit 31 performs verification between the user displayed on the authentication image and the person displayed on each installation camera image Im registered in the installation camera image DB 22, and extracts one or more installation camera images Im whose subject is determined to be the same person as the target user from the installation camera image DB 22 as the objective images Iobj. The verification in this case may be a verification based on face verification or may be a verification based on iris verification. The verification based on face authentication may be performed based on template matching, or may be performed using an inference engine obtained by learning a learning model through a machine learning such as deep learning and support vector machine. The parameters of the learning model in this case and the parameters of the feature extractor in template matching, and the like are determined through learning or the like, and are stored in advance in the storage device 2 or the like.

When the life log management device 1 receives an input signal S1 specifying the date of the life log information to be browsed from the user terminal 4, the image retrieval unit 31 retrieves the objective images Iobj from the installation camera images Im generated on the specified date in the installation camera image DB 22.

The subjective image generation unit 32 generates subjective images Isub in a case where the life log management device 1 receives the input signal S1 for instructing the display of subjective images Isub. In this case, based on the landscape DB 20 and the three dimensional model DB 21, the subjective image generation unit 32 converts the objective images Iobj retrieved by the image retrieval unit 31 to the subjective images Isub that are based on the viewpoint of the target user at the time of photographing the objective images Iobj. The objective images Iobj retrieved by the image retrieval unit 31 and the subjective image Isub generated by the subjective image generation unit 32 are time-series images according to a predetermined frame rate in a predetermined time slot (time period), respectively. Therefore, the subjective image generation unit 32 generates time-series subjective images Isub (i.e., a video file) that can be played back (reproduced) as a video. Specific process executed by the subjective image generation unit 32 will be described later.

The display control unit 33 receives the input signal S1 from the user terminal 4 via the interface 13, and then, on the basis of the received input signal S1, supplies the information on the date and the authentication image to the image retrieval unit 31 or gives instructions of generating image Isub to the subjective image generation unit 32. Further, the display control unit 33 generates a display control signal S2 for displaying a list view (also referred to as “life log list view”) of the life log on the date selected based on the input signal S1, and transmits the display control signal S2 to the user terminal 4 via the interface 13. The life log herein refers to the action history of the target user for each separated time slot in which time-series objective images Iobj exist. Further, the display control unit 33 generates the display control signal S2 for displaying a view (also referred to as “life log playback view”) indicating at least one of: the objective images Iobj supplied from the image retrieval unit 31; or the subjective images Isub supplied from the subjective image generation unit 32. Then, the display control unit 33 transmits the display control signal S2 to the user terminal 4 via the interface 13. The display examples of the life log list view and the life log playback view will be described later.

Each component of the image retrieval unit 31, the subjective image generation unit 32, and the display control unit 33 described in FIG. 4 can be realized, for example, by the processor 11 executing the program. More specifically, each component may be implemented by the processor 11 executing a program stored in the memory 12. In addition, the necessary programs may be recorded in any nonvolatile recording medium and installed as necessary to realize each component. Each of these components is not limited to being implemented by software using a program, and may be implemented by any combination of hardware, firmware, and software.

Each of these components may also be implemented using user programmable integrated circuit, such as, for example, FPGA (field-programmable gate array) or a microcomputer. In this case, the integrated circuit may be used to realize a program to function as each of the above-described components. Thus, each component may be implemented by hardware other than the processor 11. The above is the same in other example embodiments to be described later.

(4-2) Details of Subjective Image Generation Unit

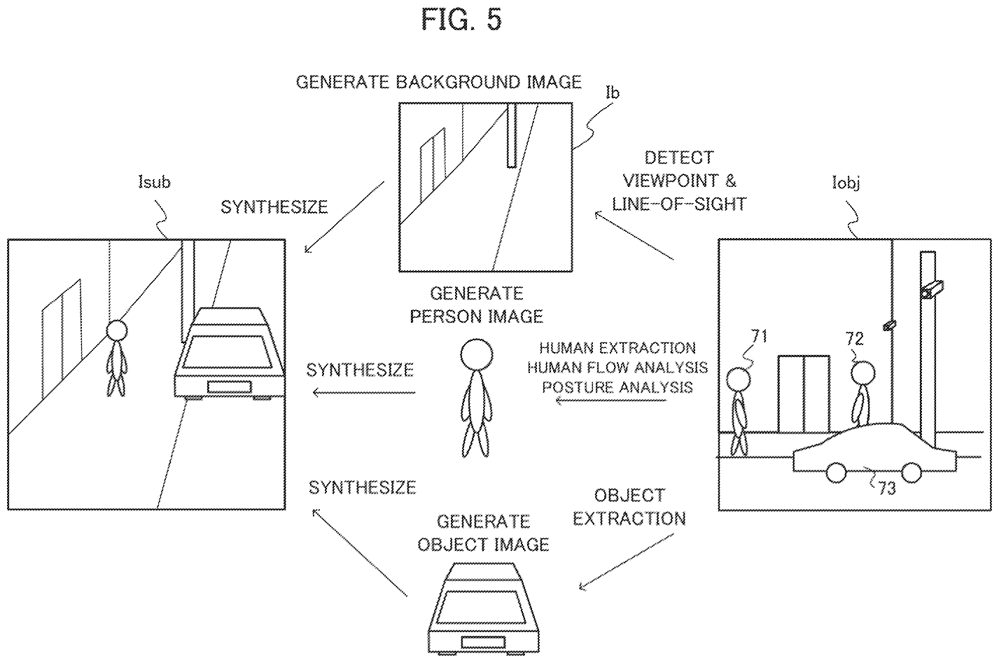

FIG. 5 is a diagram showing an outline of the process executed by the subjective image generation unit 32. Here, as an example, the subjective image generation unit 32 generates a subjective image Isub from an objective image Iobj including, as subjects, the target user 71, the peripheral person 72 existing in the vicinity of the target user, and the peripheral object (a vehicle herein) 73 that is an object other than a person present in the vicinity of the target user.

As shown in FIG. 5, first, the subjective image generation unit 32 detects the viewpoint and the line-of-sight direction of the target user from the objective image Iobj supplied from the image retrieval unit 31 thereby to generate a background image “Ib” to be used for generating the subjective image Isub. Further, the subjective image generation unit 32 extracts the peripheral person 72 existing around the target user from the objective image Iobj, and generates a person image “Ip” indicating the peripheral person 72 on the background image Ib. In this case, as will be described later, the subjective image generation unit 32 generates the person image Ip by executing either the human extraction process and the posture analysis process or the human flow analysis process on the objective image Iobj. Further, the subjective image generation unit 32 detects the peripheral object 73 that is an object, other than human, existing in the vicinity of the target user from the objective image Iobj, and generates an object image “Io” representing the peripheral object 73 on the background image Ib. Then, the subjective image generation unit 32 generates the subjective image Isub obtained by synthesizing the background image Ib, the person image Ip, and the object image Io.

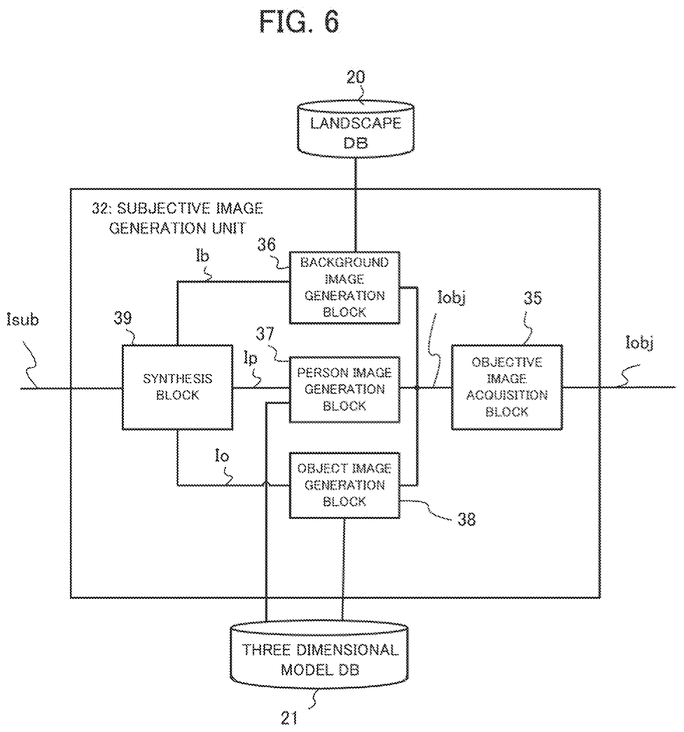

FIG. 6 is an example of an internal functional block of the subjective image generation unit 32 which executes the process shown in FIG. 5. The subjective image generation unit 32 functionally includes an objective image acquisition block 35, a background image generation block 36, a person image generation block 37, an object image generation block 38, and a synthesis block 39.

The objective image acquisition block 35 acquires the objective image Iobj supplied from the image retrieval unit 31. Then, the objective image acquisition block 35 supplies the acquired objective image Iobj to the background image generation block 36, the person image generation block 37, and the object image generation block 38, respectively.

The background image generation block 36 generates, based on the objective image Iobj supplied from the objective image acquisition block 35, the background image Ib for use to generate the subjective image Isub. In this case, the background image generation block 36 first calculates, based on the objective image Iobj, the absolute viewpoint and the line-of-sight direction of the target user in the real space, then retrieves, from the landscape DB 20, the landscape image captured from a camera at the position and the posture approximating (close to) the calculated viewpoint and the line-of-sight direction.

Here, the calculation method of the absolute viewpoint and the line-of-sight direction of the target user will be specifically described. The objective image Iobj supplied from the objective image acquisition block 35 includes, as metadata, the camera position information indicating the position of the installation camera 5 that generated the objective image Iobj and the camera posture information indicating the posture (orientation) of the installation camera 5 and the like. Therefore, the background image generation block 36 identifies, based on the camera position information and the camera posture information described above, the position and posture of the installation camera 5 that captured an objective image Iobj. Further, through a known image analysis on the objective image Iobj, the background image generation block 36 identifies the relative position and posture (the direction of the face and the line-of-sight direction) of the target user's face with respect to the installation camera 5. In this case, the background image generation block 36 may determine the relative position and the relative posture of the target user in the objective image Iobj with respect to the installation camera 5 by inputting the objective image Iobj to an inference engine configured by referring to parameters learned in advance by machine learning. In this case, the inference engine described above is a learning model that is learned, based on deep learning or other machine learning, to infer, from the input image, the relative position of the person in the image with respect to the camera and the relative posture of the person with respect to the camera, respectively. Then, the background image generation block 36 calculates the absolute viewpoint and the line-of-sight direction of the target user in the real space, based on the position and posture of the installation camera 5 and the relative position and posture of the target user's face with respect to the installation camera 5.

In a case where there are a plurality of objective images Iobj generated at the same time by a plurality of installation cameras 5, the background image generation block 36 may calculate the absolute viewpoint and the line-of-sight direction of the target user from the plurality of objective images Iobj.

After the calculation of the absolute viewpoint and the line-of-sight direction of the target user, by referring to the landscape DB 20, the background image generation block 36 selects, as the background image Ib, the landscape image associated with the camera position information and the camera posture information which are most similar to the calculated viewpoint and line-of-sight direction. In this case, for example, the background image generation block 36 calculates a predetermined evaluation function using, as parameters, the distance between the absolute viewpoint of the target user and the position indicated by the camera position information and the angle difference between the absolute line-of-sight direction of the target user and the direction indicated by the camera posture information. Then, the background image generation block 36 selects the background image Ib that is the landscape image associated with the camera position information and the camera posture information whose evaluation function value is the smallest. Information on the evaluation function is stored in advance in the storage device 2. Thus, the background image generation block 36 can select the background image Ib that is the landscape image captured by the position and the posture approximating the viewpoint and the line-of-sight direction of the target user at the time of generating the objective image Iobj.

In some embodiments, the background image generation block 36 may modify the landscape image extracted from the landscape DB 20 to approximate the image captured from the viewpoint and the line-of-sight direction of the target user at that time. In this case, using a known viewpoint conversion technique, the background image generation block 36 converts the landscape image so that the distance between the absolute viewpoint of the target user and the viewpoint of the landscape image and the angle difference between the absolute line-of-sight direction of the target user and the imaging direction of the landscape image is reduced, respectively.

Further, the background image generation block 36 may adjust the brightness of the background image Ib according to the target time of the objective image Iobj. For example, the background image generation block 36 determines the time slot, daytime, evening, or night, which the target time corresponds to, and adjusts the brightness of the background image Ib according to the determined time slot. In this case, for example, the background image generation block 36 stores parameters of filters each configured to be suitable for each time slot in advance in the storage device 2 or the like, and applies the filter based on the parameters corresponding to the determined time slot to the background image Ib, thereby processing the background image Ib so as to obtain a brightness suitable for the target time.

The person image generation block 37 detects a person (also referred to as “peripheral person”) existing in the vicinity of the target user from the objective image Iobj, and generates a person image Ip which is a computer graphics (CG) simulating the detected peripheral person.

In this case, first, through the image recognizing process on the objective image Iobj, the person image generation block 37 calculates the position and the posture of the peripheral person relative to the installation camera 5 which generated the objective image Iobj. Thereafter, the person image generation block 37 converts the relative position and posture of the peripheral person with respect to the installation camera 5 that generated the objective image Iobj to the position and posture of the peripheral person with respect to a camera serving as a viewpoint of the background image Ib. In this case, the person image generation block 37 performs the above-mentioned conversion based on: the camera position information and the camera posture information corresponding to the background image Ib generated by the background image generation block 36; and the camera position information and the camera posture information corresponding to the objective image Iobj.

Next, the person image generation block 37 configures a three dimensional model of a person by referring to the three dimensional model DB 21, and generates a person image Ip in which the three dimensional model is projected onto the same two-dimensional coordinates as the background image Ib from the viewpoint and the line-of-sight direction of the background image Ib. Then, the person image generation block 37 supplies the generated person image Ip to the synthesis block 39. The person image Ip is, for example, a mask image having the same size as the background image Ib. When the target peripheral person was imaged by a plurality of installation cameras 5, the person image generation block 37 may measure the three dimensional shape of the peripheral person based on the three dimensional stereo measurement method. In this case, the person image generation block 37 generates the person image Ip obtained by projecting the measured three dimensional shape of the peripheral person onto the two-dimensional space of the background image Ib.

Instead of detecting each peripheral person in one objective image Iobj, the person image generation block 37 may perform a human flow analysis on time-series objective images Iobj to generate the person image Ip based on the human flow analysis result. In this case, the person image generation block 37 detects the flow (i.e., approximate moving direction) of peripheral persons as a group by the human flow analysis, and generates the person image Ip that is a computer graphics of people moving along the detected flow. In this case, the number and the position of the peripheral persons captured in the objective image Iobj may not coincide with the number and the position of the persons represented by the person image Ip to be generated. Even in this case, the person image generation block 37 can preferably generate the person image Ip so that the rough flow of the people existing in the vicinity of the target user can be represented by the subjective image Isub.

The object image generation block 38 detects an object (also referred to as a “peripheral object”) other than a person existing in the vicinity of the target user from the objective image Iobj and generates the object image Io which is a computer graphics (CG) simulating the detected peripheral object. In this case, the object image generation block 38 detects the position and the posture of the peripheral object with respect to the camera serving as the viewpoint of the background image Ib, in the same way as the generation of the person image Ip. Then, the object image generation block 38 configures, by referring to the three dimensional model DB 21, a three dimensional model corresponding to the type of the target object, and generates the object image Io obtained by projecting the three dimensional model onto the same two-dimensional coordinates as the background image Ib from the viewpoint and the line-of-sight direction of the background image Ib. The object image Io is, for example, a mask image having the same size as the background image Ib. Then, the object image generation block 38 supplies the object image Io to the synthesis block 39. If the peripheral object was photographed by a plurality of installation cameras 5, the object image generation block 38 measures the three dimensional shape of the peripheral object based on the three dimensional stereo measurement method, and generates the object image Io obtained by projecting the measured three dimensional shape onto the two-dimensional space of the background image Ib.

The synthesis block 39 generates the subjective image Isub obtained by superimposing the person image Ip supplied from the person image generation block 37 and the object image Io supplied from the object image generation block 38 on the background image Ib supplied from the background image generation block 36.

The subjective image generation unit 32 performs the above-mentioned process on each of time-series objective images Iobj that constitutes a video in a time slot with a predetermined time length generated from the installation camera 5 to thereby generate time-series subjective images Isub in the time slot. Thus, the subjective image generation unit 32 can suitably generate a subjective video of the target user in the time slot based on the video of the target user captured in the time slot with the predetermined time length by the installation camera 5.

(5) Display Example

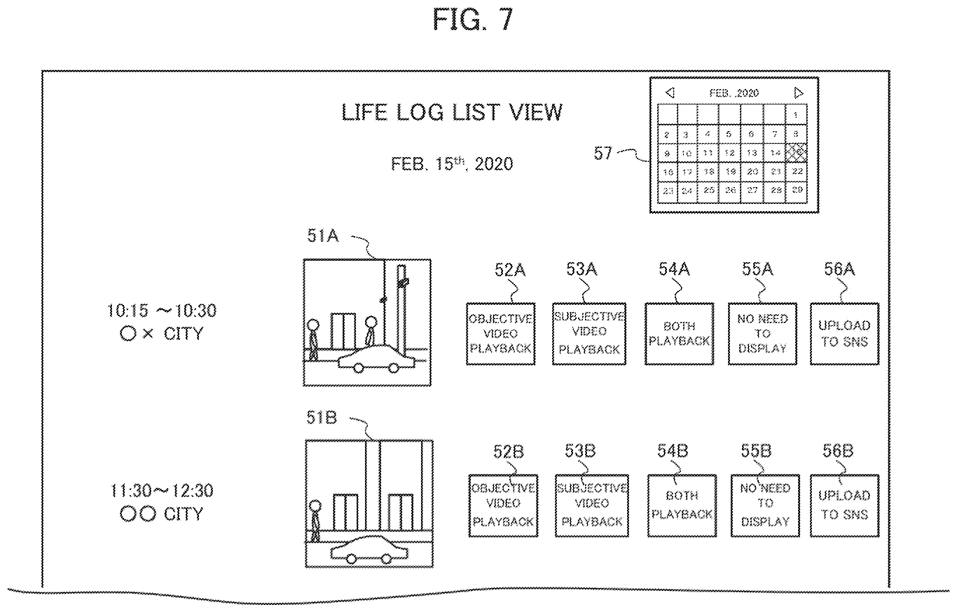

FIG. 7 shows an example of a life log list view displayed on the user terminal 4 based on the display control signal S2 transmitted from the life log management device 1. In the example of FIG. 7, the life log management device 1 receives the selection of the date and time for browsing the life log after passing the login authentication of the user terminal 4, and generates the display control signal S2 for displaying the life log list view corresponding to the selected date and time (here, Feb. 15, 2020).

The life log management device 1 retrieves the objective images Iobj in which the target user is continuously captured from installation camera images Im registered in the installation camera image DB 22 whose shooting date and time matches the target date. The life log management device 1 displays a list of life logs corresponding to a combination of the shooting time and shooting location corresponding to the retrieved time series objective images Iobj and a thumbnail image (here, a thumbnail images 51A, 51B) representing the target time series objective images Iobj. Specifically, the life log management device 1 displays a thumbnail image 51A corresponding to the shooting date and time “10:15 to 10:30” and the shooting location “∘×city” and a thumbnail image 51B corresponding to the shooting date and time “11:30 to 12:30” and the shooting location “∘∘ city” side by side. The life log management device 1 identifies the above-described shooting date and time and the shooting location to be displayed on the life log list view, based on “shooting date and time” and “camera position information” associated with the installation camera images Im corresponding to the target objective images Iobj.

Further, for each combination of the shooting time and the shooting location and the thumbnail images 51A and 51B, a user interface for instructing the process on the target time-series objective images Iobj is disposed. Here, as the user interface, objective video playback buttons 52A and 52B, subjective video playback buttons 53A and 53B, both playback buttons 54A and 54B, non-display buttons 55A and 55B, and SNS (Social Networking Service) upload buttons 56A and 56B.

The objective video playback buttons 52A and 52B each is a button that instructs the playback of the corresponding time series objective images Iobj (simply referred to as “objective video”). When detecting the selection of any of the objective video playback buttons 52A and 52B, the life log management device 1 generates the display control signal S2 for displaying the life log playback view for playing back the corresponding objective video, and transmits the display control signal S2 to the user terminal 4.

The subjective image playback buttons 53A and 53B each is a button that instructs the playback of the time series subjective images Isub (simply referred to as “subjective video”) converted from the corresponding time series objective images Iobj. When detecting the selection of any of the subjective video playback buttons 53A and 53B, the life log management device 1 generates the display control signal S2 for displaying the life log playback view for playing back the corresponding subjective video, and transmits the display control signal S2 to the user terminal 4.

The both playback buttons 54A and 54B each is a button that instructs to play both the corresponding objective video and subjective video. When detecting the selection of any of the two playback buttons 54A and 54B, the life log management device 1 generates a display control signal S2 for displaying a life log playback view for playing back both the corresponding objective video and the subjective video with the time axis aligned, and transmits the display control signal S2 to the user terminal 4.

The non-display buttons 55A and 55B each is a button to indicate that the display of the corresponding objective video and the subjective video is not necessary. When the life log management device 1 detects the selection of any of the non-display buttons 55A and 55B, it hides the corresponding life log (i.e., the thumbnail image and various buttons). As described above, the life log management device 1 hides the life log in the time slot determined, by the target user, to be not necessary to retain it in the life log list view.

The SNS upload buttons 56A and 56B each is a button that indicates that the corresponding objective or subjective video is to be uploaded to a system of any SNS of the target user. When detecting the selection of any of the SNS upload buttons 56A and 56B, the life log management device 1 displays, for example, a window that receives an input that specifies an SNS to be uploaded and an input that specifies an image (objective image Iobj or subjective image Isub) or a video to be uploaded. The life log management device 1 transmits the specified image or video to the specified SNS system based on the received inputs.

The life log management device 1 displays the target day selection calendar 57 on the life log list view shown in FIG. 7. Then, when detecting the selection of a particular date on the target date selection calendar 57, the life log management device 1 searches for the objective images Iobj from the installation camera images Im registered in the installation camera image DB 22 whose shooting date and time matches the selected date. Then, the life log management device 1 generates a display control signal S2 for updating the life log list view based on the search result, and transmits the display control signal S2 to the user terminal 4. Therefore, the target user can browse the list of life logs on any date based on the operation to the target date selection calendar 57.

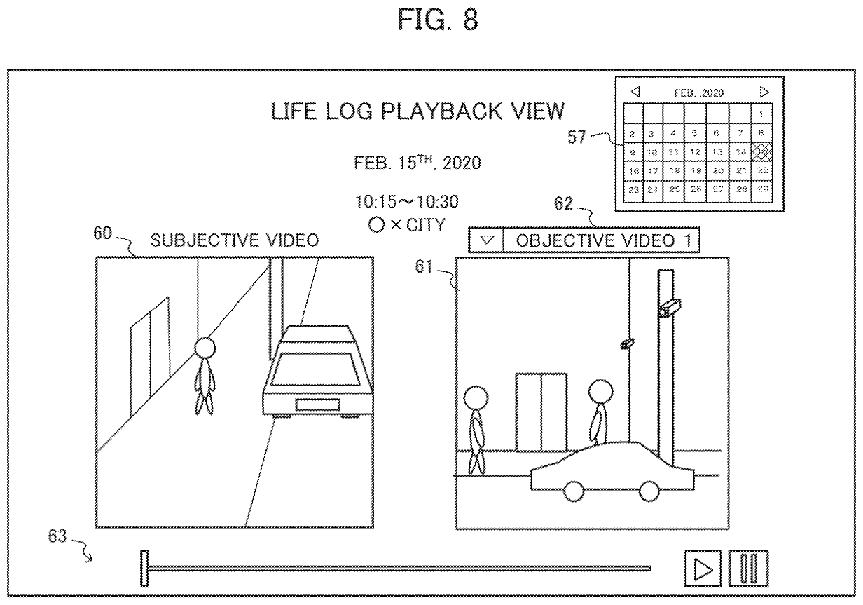

FIG. 8 shows an example of a life log playback view displayed by the user terminal 4 based on the display control signal S2 transmitted from the life log management device 1. The life log management device 1 displays at least one of the objective video or the subjective video corresponding to the life log specified on the life log list view on the life log playback view. In the example of FIG. 8, the life log management device 1 detects the selection of the both playback button 54A corresponding to the shooting date and time “10:15 to 10:30” and the shooting location “∘×city” after the display of the life log list view shown in FIG. 7, and displays the life log playback view for displaying the subjective video and the objective video corresponding to the selected shooting date and time and the shooting location on the user terminal 4.

As illustrated in FIG. 8, the life log management device 1 mainly displays the target day selection calendar 57, the subjective video playback field 60, the objective video playback field 61, the objective video selection field 62, and the playback controller 63 on the life log playback view. The playback controller 63 includes a playback bar indicating the transition of the time during playback in the target time slot (here time slot from 10:15 to 10:30), a playback button, and a pause button.

The life log management device 1 plays back the target subjective video on the subjective image playback field while playing back the target objective video on the objective image playback field 61. Further, when the target user are captured by multiple installation cameras 5 at the time indicated by the playback bar, the life log management device 1 accepts the selection of the objective video to be displayed on the objective video reproduction field 61 by the objective video selection field 62.

Thus, the life log management device 1 generates the display control signal S2 of the life log playback view for the playback of the objective video or/and subjective video specified by the target user, and transmits the display control signal S2 to the user terminal 4. Thus, the life log management device 1 can present, to the target user, the life log information that is the objective video (objective images Iobj) or/and the subjective video (subjective images Isub) at any point in the past in which the target user is photographed by any installation camera 5.

(6) Processing Flow

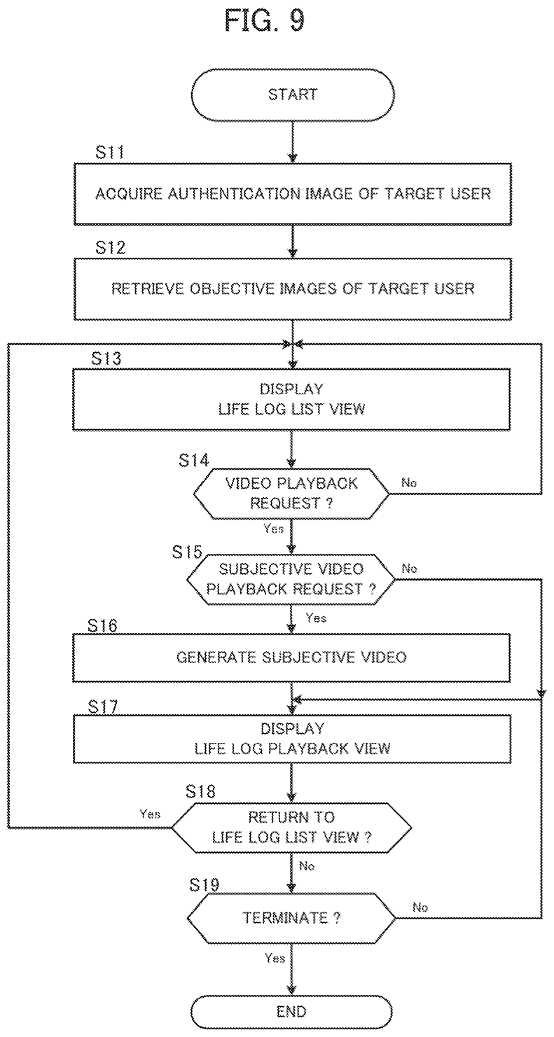

FIG. 9 is an example of a flowchart illustrating a processing procedure executed by the life log management device 1 with respect to the display process of the life log list view and the life log playback view according to the first example embodiment. The life log management device 1 executes the processing of the flowchart shown in FIG. 9 when a request for displaying a life log is received from the user terminal 4.

First, the life log management device 1 acquires the authentication image obtained by photographing the target user which uses the user terminal 4 (step S11). In this case, the user terminal 4 generates the authentication image by the camera 8, and transmits the authentication image to the life log management device 1. Thereafter, the life log management device 1 retrieves the objective images Iobj of the target user by performing verification between the authentication image acquired at step S11 and each installation camera image Im registered in the installation camera image DB 22 (step S12). Thus, the life log management device 1 extracts the objective images Iobj of the target user from the installation camera images Im registered in the installation camera image DB 22. If the information on the specified date has been received from the user terminal 4 after step S11, the life log management device 1 may extract the objective images Iobj of the target user from the installation camera images Im captured on the specified date.

Next, the life log management device 1 generates the display control signal S2 for displaying the life log list view, and transmits the display control signal S2 to the user terminal 4 to display the life log list view on the display device 7 (step S13). In this case, the user terminal 4 supplies the display device 7 with the display control signal S2 received from the life log management device 1 or a signal that is the display control signal S2 converted into a format which can be handled by the display device 7 to thereby display the life log list view on the display device 7. For example, before displaying the life log list view, the life log management device 1 accepts the selection of the date of the life log to be displayed, and generates the display control signal S2 of the life log list view showing the list of life logs regarding the selected date.

Next, the life log management device 1 determines whether or not there is a video playback request relating to at least one of the objective video or the subjective video in a specific time slot (step S14). In the example of the life log list view shown in FIG. 7, the life log management device 1 determines whether or not there is a selection of any of the buttons 52A to 54A, 52B to 54B that instructs the playback of at least one of the objective video or the subjective video in a particular time slot (time period). When there is no video playback request (step S14: No), the life log management device 1 continuously displays the life log list view at step S13.

On the other hand, when there is a video playback request (step S14; Yes), the life log management device 1 determines whether or not there is a subjective video playback request (step S15). Then, when there is a subjective video playback request (step S15; Yes), the life log management device 1 generates the subjective video (step S16). In this case, in accordance with the process outline executed by the subjective image generation unit 32 illustrated in FIGS. 5 and 6, the life log management device 1 converts each objective image Iobj captured in time series in the time slot specified by the target user into the subjective image Isub by referring to the landscape DB 20 and the three dimensional model DB 21. Thus, the life log management device 1 generates a subjective video in a time slot specified by the target user. Then, the life log management device 1 generates the display control signal S2 for displaying the life log playback view, and then, by transmitting the display control signal S2 to the user terminal 4, displays the life log playback view on the display device 7 (step S17). Thus, the life log management device 1 can suitably present to the target user at least one of the objective video or the subjective video of the target user at a specific date and time designated by the target user.

Next, the life log management device 1 determines whether or not the display should be returned to the life log list view (step S18). When it is determined that the display should be returned to the life log list view (step S18: Yes), the life log management device 1 returns to the display process of the life log list view at step S13. For example, when an input for selecting another date is detected on the life log playback view, the life log management device 1 determines that a life log list view showing a list of life logs on the selected date should be displayed, and performs the display processing of the life log list view at step S13.

On the other hand, when it is determined that the display should not be returned to the life log list view (step S18: No), the life log management device 1 determines whether or not the processing of the flowchart should be completed (step S19). For example, when the life log management device 1 detects a user input that instructs termination of the display regarding the life log, it determines that the processing of the flowchart should be terminated. Then, when it is determined that the processing of the flowchart should be terminated (step S19; Yes), the life log management device 1 terminates the process of the flowchart. On the other hand, when it is determined that the processing of the flowchart should not be terminated (step S19; No), the life log management device 1 continuously performs display process of the life log playback view at step S17.

As described above, the life log management system 100 according to the first example embodiment can suitably provide the target user with the objective video and the subjective video which serve as the life log by using the installation cameras 5 existing in cities as the device for recording viewpoints and behaviors of people. In this case, the target user can look back his own behavior by two viewpoints of a pseudo-subjective video and an objective video without wearing a wearable type camera which was conventionally required to generate life logs.

(7) Modification

Next, modifications suitable for the above-described example embodiment will be described. The following modifications may be optionally combined to be applied to the example embodiment described above.

(First Modification)

Instead of receiving, from the user terminal 4, the input signal S1 including the authentication image of the target user to be cross-checked with the installation camera images Im, the life log management device 1 may acquire the authentication image stored in advance in the storage device 2 from the storage device 2.

In this case, the authentication image for each user ID of possible target users is stored in the storage device 2, and the life log management device 1 acquires the authentication image to be used from the storage device 2 based on the user ID at the time of login of the target user by the user terminal 4. In this case, the user terminal 4 does not necessarily have to be connected to the camera 8 at the time when the target user uses the life log management system 100.

Further, the storage device 2 may store, instead of the authentication image, the information on the feature values representing the biological characteristics of the target user extracted in advance from the authentication image.

(Second Modification) In the process executed by the subjective image generation unit 32 shown in FIG. 6, the detection of the viewpoint and the line-of-sight direction of the target user to be executed by the background image generation block 36 may be executed by the installation camera 5 or a device (registering device) configured to register installation camera images Im generated by the camera 5 in the installation camera image DB 22.

In this case, the installation camera 5 or the registering device detects one or more persons in the installation camera image Im generated by the installation camera 5 and executes detection process of the viewpoint and the line-of-sight of each detected person. Then, the installation camera 5 or the registering device registers the information on the viewpoint and the line-of-sight direction, which are the result of the above-described detection process, in the installation camera image DB 22 in association with the target installation camera image Im. Therefore, in this case, the installation camera image DB 22 includes, in addition to the respective information shown in FIG. 2B, information on the viewpoint and the line-of-sight direction of each person shown in the installation camera image Im.

According to this example, the background image generation block 36 can suitably generate the background image Ib by referring to information on the viewpoint and the line-of-sight direction of the target user associated with the objective image Iobj of interest, instead of performing the detection process of the viewpoint and the line-of-sight direction.

(Third Modification)

The life log management device 1 may perform at least one of the retrieval process of an objective image Iobj and the generation process of the subjective image Isub by referring to information (also referred to as “user information”) on the behavior of the target user.

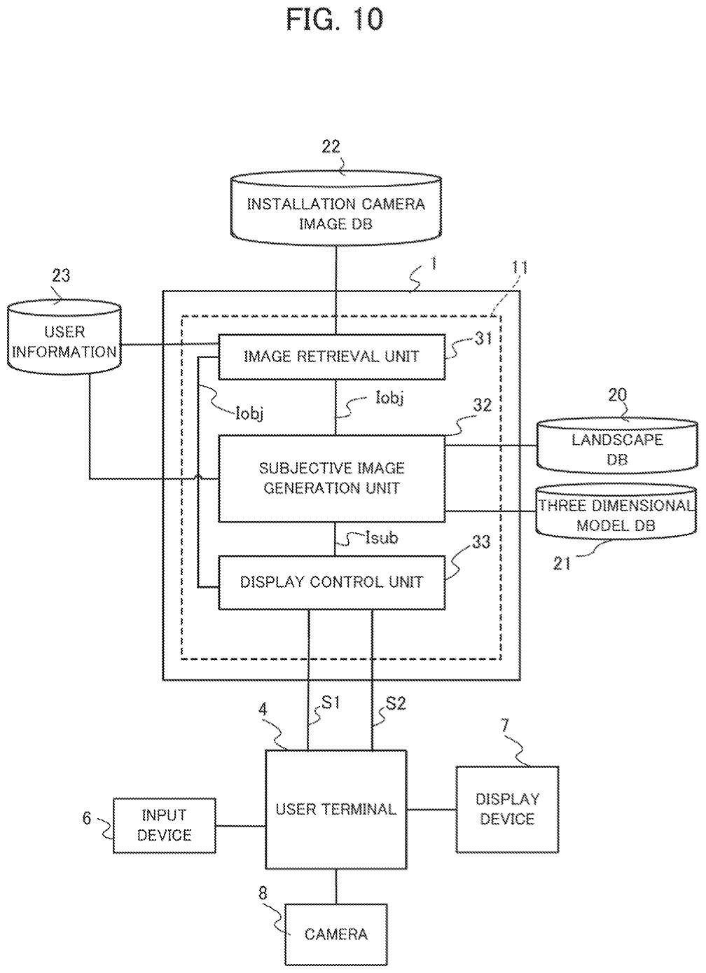

FIG. 10 is a functional block diagram of the processor 11 according to the third modification. As illustrated in FIG. 10, the life log management device 1 refers to the user information 23. Here, the user information 23 is information with which the past behavior of the target user can be identified, and may be stored in the storage device 2 or may be stored in a device (not shown) that manages the behavior of the target user. Examples of the user information 23 include history information (referred to as “position history information”) on the positions of the target user in the past, history information (also referred to as “purchase history information”) on the purchases of products by the target user in the past, and past schedule information of the target user. If the user information 23 is the position history information, the user information 23 is, for example, information in which the position information of the user terminal 4 measured by positioning device such as a GPS receiver provided at the user terminal 4 is associated with the measurement date and time. The position information of the user terminal 4 may be the position information of the user terminal 4 identified based on the signal received from a beacon terminal or a wireless LAN device. If the user information 23 is purchase history information, the user information 23 is, for example, information in which the identification information of the purchased product is associated with at least the purchase date and time.

Then, the image retrieval unit 31 refers to the user information 23 and retrieves the objective images Iobj of the target user from the installation camera images Im stored in the installation camera image DB 22. For example, if the user information 23 is the position history information or the schedule information, the image retrieval unit 31 specifies, on a time series basis, one or more installation cameras 5 that are present around the position of the target user to be specified based on the position history information or the schedule information. In this case, based on the position information of each installation camera 5, the image retrieval unit 31 specifies, on a time series basis, one or more installation cameras 5 that exist within a predetermined distance from the position of the target user or within the district, that is an area in units of municipalities, of the target user. Then, the image retrieval unit 31 retrieves the objective image Iobj from the installation camera images Im generated by the installation cameras 5 specified on the time series basis.

As described above, by referring to the user information 23 with which the previous position of the target user can be identified, the image retrieval unit 31 suitably limits the installation camera images Im to be searched and searches for the objective images Iobj at high speed and with high accuracy. By identifying the position of the target user at the purchase date and time based on the purchase store information or the like included in the purchase history information, the image retrieval unit 31 may specify the installation cameras 5 which generated the installation camera images Im to be searched.

Further, the subjective image generation unit 32 generates the subjective image Isub with high accuracy by using the purchase history information. For example, if the target user carries the purchased product before and after the purchase date and time indicated by the purchase history information, the subjective image generation unit 32 specifies the purchased product carried by the target user based on the purchase history information and generates the texture of the purchased product to be displayed on the subjective image Isub. In this case, if the three dimensional model of the purchased product is recorded in the three dimensional model DB 21, the subjective image generation unit 32 may generate the information of the image area of the purchased product in the subjective image Isub using the three dimensional model.

(Fourth Modification)

The life log management device 1 may store the objective images Iobj retrieved from the installation camera image DB 22 and the generated subjective images Isub, as a life log database, in the storage device 2.

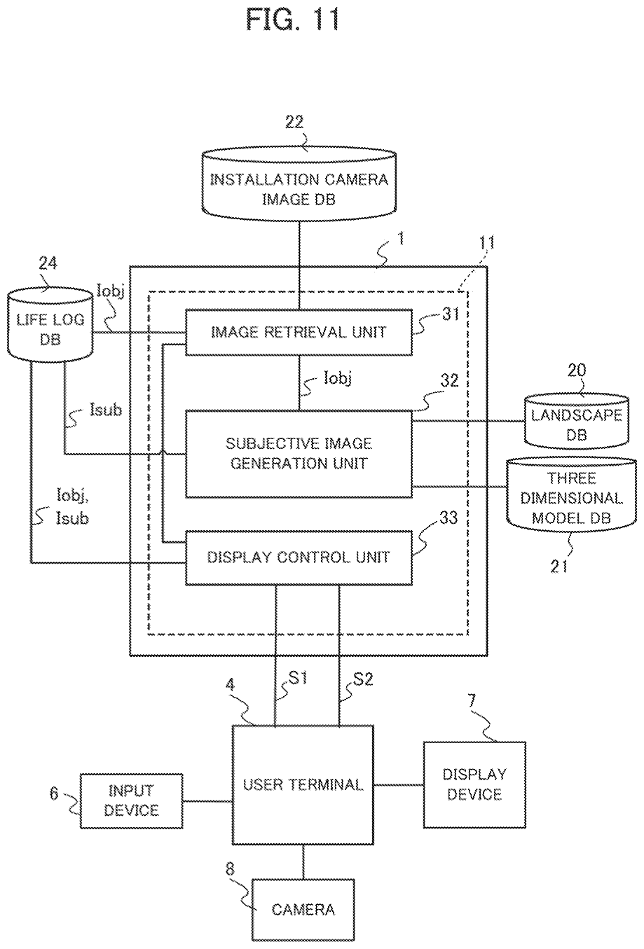

FIG. 11 illustrates an example of a functional block of processor 11 configured to update and refer to a life log DB 24. The life log DB 24 is a data base that stores life logs of the target user.

In this case, the image retrieval unit 31 stores the objective images Iobj retrieved from the installation camera image DB 22 in the life log DB 24 at a predetermined timing. The predetermined timing may be a timing at predetermined time intervals or it may be a timing at which the target user has logged in. The subjective image generation unit 32 generates subjective images Isub from the objective images Iobj retrieved by the image retrieval unit 31 and stores the generated subjective images Isub in the life log DB 24. These objective images Iobj and the subjective images Isub are, for example, associated with information on the shooting date and time and the user ID of the target user. The subjective image generation unit 32 may generate the target subjective images Isub only when receiving a request for the display of the subjective images Isub (subjective video) from the user terminal 4. In another example, the subjective image generation unit 32 may generate the subjective images Isub corresponding to all the objective images Iobj registered in the life log DB 24.

The display control unit 33 generates the display control signal S2 by extracting the objective images Iobj or/and the subjective images Isub required for displaying the life log list view or the life log playback view from the life log DB 24. Then, the display control unit 33 transmits the display control signal S2 to the user terminal 4.

As described above, according to the present modification, by referring to the life log DB 24 for each target user, the life log management device 1 can suitably reduce the load at the time of displaying the life log list view and the life log playback view.

(Fifth Modification)

At the time of the playback of the objective video or the subjective video, the user terminal 4 may further output the sound recorded by the installation camera 5 at the corresponding time.

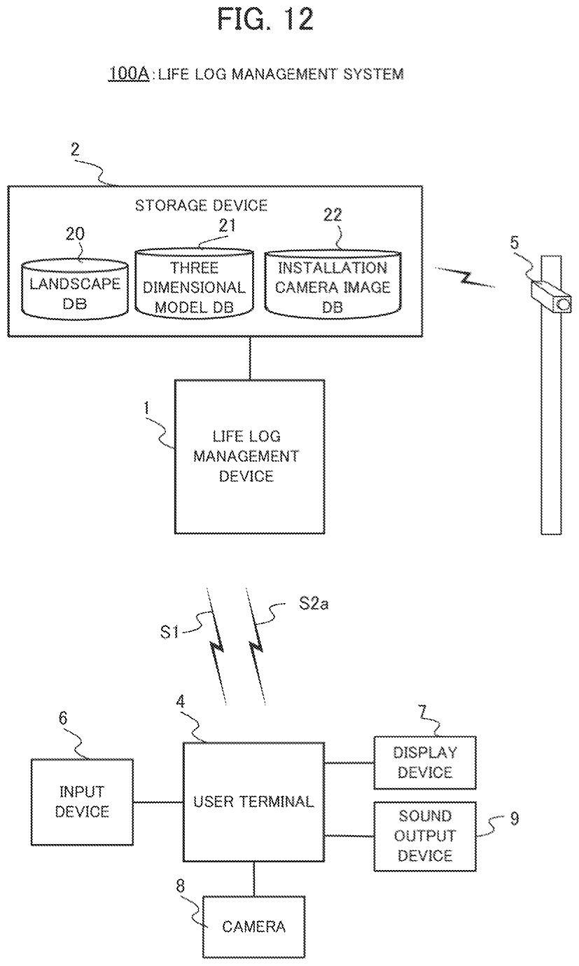

FIG. 12 shows the configuration of the life log control system 100A in the fifth modification. In this case, the user terminal 4 is electrically connected to a sound output device 9. The installation cameras 5 further generate sound data indicating the sound picked up by microphone or the like. The installation camera image DB 22 stores the sound data generated by installation cameras 5 in association with information on the shooting date and time and information on the installation cameras 5.

Then, if there is a playback request of the objective video or the subjective video, the life log management device 1 extracts, from the installation camera image DB 22, sound data generated at the same time by the same installation camera 5 as the target installation camera images Im of playback were captured. Then, the life log management device 1 transmits to the user terminal 4 the control signal “S2a” which includes the extracted sound data in addition to the target video of the playback request. Namely, the control signal S2a is a control signal that is the display control signal S2 described in the example embodiment described above to which the sound data is optionally added. Then, the user terminal 4 displays, based on the control signal S2a, the objective video or subjective video by the display device 7 while outputting the sound by the sound output device 9. Thus, the life log management device 1 can present a life log with a more realistic sense to the target user. It is noted that the sound output device 9 that exists independently is an example and it may be built into the user terminal 4 or may be configured integrally with the display device 7.

(Six Modification)

When the display device 7 is a head-mounted display, the life log management device 1 may generate the subjective images Isub to be presented to the target user as the subjective video based on the line-of-sight direction of the target user detected by the display device 7.

In this case, the display device 7 is provided with a sensor for detecting a line-of-sight direction of the target user who wears the display device 7, and the user terminal 4 supplies information (also referred to as “line-of-sight information”) indicative of a line-of-sight direction of the target user detected by the display device 7 to the life log management device 1 during playback of the subjective video. The sensor described above is one or more sensors that are typically equipped in a typical head-mounted display, such as a sensor (e.g., acceleration sensor) configured to detect the orientation of the face of the target user who wears the display device 7 and a sensor (e.g., camera) configured to detect the direction of the line-of-sight relative to the frontal direction of the face. Then, the life log management device 1 changes, based on the variation in the line-of-sight direction received from the user terminal 4, the line-of-sight direction to be used, as a reference, to display the subjective images Isub on the display device 7. Specifically, the subjective image generation unit 32 of the life log management device 1 changes, based on the variation in the line-of-sight direction received from the user terminal 4, the line-of-sight direction detected when generating the background image Ib. Then, the subjective image generation unit 32 generates each subjective image Isub by superimposing the person image Ip and the object image Io generated based on the three dimensional model DB 21 on the background image Ib in which the line-of-sight information is reflected. Then, the display control unit 33 streams the subjective images Isub generated by the subjective image generation unit 32 to the display device 7 via the user terminal 4 to thereby allow the target user who wears the display device 7 to visually recognize the subjective images Isub according to the line-of-sight direction of the target user.

Thus, when the display device 7 is a head-mounted display, the life log management device 1 generates subjective images Isub in which the direction of the line-of-sight of the wearer of the display device 7 is reflected, thereby presenting a life log in a form with a more sense of reality.

### Second Example Embodiment

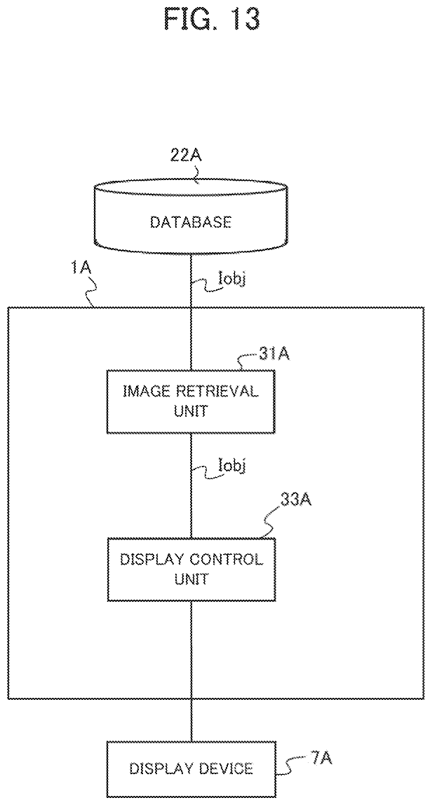

FIG. 13 is a schematic configuration diagram of a life log management device 1A according to a second example embodiment. As shown in FIG. 13, the life log management device 1A mainly includes an image retrieval unit 31A and a display control unit 33A.

The image retrieval unit 31A is configured to retrieve an objective image Iobj in which a target user is photographed from a database 22A of installation camera images generated by a camera installed in a public place. The “camera installed in a public place” may be an installation camera 5 in the first example embodiment. Further, the database 22A may be an installation camera image DB 22 in the first example embodiment.

The display control unit 33A is configured to display life log information based on the objective image Iobj on a display device 7A. Here, examples of the life log information include the shooting date and time displayed on the life log list view shown in FIG. 7, the shooting location and thumbnail image, and the objective video (objective images Iobj) and the subjective video (subjective images Isub) displayed on the life log playback view shown in FIG. 8. Examples of the display device 7A include the display device 7 according to the first example embodiment and a combination of the user terminal 4 and the display device 7.

According to the configuration in the second example embodiment, the life log management device 1A can suitably present the life log information recording the target user on a daily basis to the target user without requiring the target user to wear any wearable camera.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments described above can be described as, but not limited to, the following Supplementary Notes.

[Supplementary Note 1]

A life log management device comprising:

an image retrieval unit configured to retrieve an objective image in which a target user is photographed from a database of installation camera images generated by a camera installed in a public place; and

a display control unit configured to display life log information based on the objective image on a display device.

[Supplementary Note 2]

The life log management device according to Supplementary Note 1,

wherein the display control unit is configured to display, on the display device, the life log information,

the life log information including at least one of:
the objective image; or
a subjective image based on a viewpoint and a line-of-sight direction of the target user shown in the objective image.

[Supplementary Note 3]

The life log management device according to Supplementary Note 2, further comprising

a subjective image generation unit configured to generate the subjective image using a landscape image searched for from a database of landscape images representing a landscape in the public place,

the landscape image being searched for based on the viewpoint and the line-of-sight direction.

[Supplementary Note 4]

The life log management device according to Supplementary Note 3,

wherein the subjective image generation unit is configured to generate the subjective image obtained by superimposing
an image representing a person captured in the objective image other than the target user and
an image representing an object captured in the objective image other than human
on a background image generated based on the landscape image.

[Supplementary Note 5]

The life log management device according to any one of Supplementary Notes 2 to 4,

wherein the display control unit is configured to simultaneously play back, on the display device,
an objective video obtained by the objective image in time series and
a subjective video obtained by the subjective image in time series in a same time slot as the objective image in time series.

[Supplementary Note 6]

The life log management device according to Supplementary Note 3 or 4,

wherein the display device is a head-mounted display, and

wherein the subjective image generation unit is configured to change,
based on line-of-sight information regarding the target user detected by the head-mounted display,
the line-of-sight direction to be used as a reference for generating the subjective image.

[Supplementary Note 7]

The life log management device according to any one of Supplementary Notes 1 to 6,

wherein the image retrieval unit is configured to retrieve the objective image from the database of the installation camera images based on an authentication image for authenticating the target user.

[Supplementary Note 8]

The life log management device according to any one of Supplementary Notes 1 to 7,

wherein the display control unit is configured to display, on the display device, a list of time slots, on a specified date, in which the objective image is present together with a user interface for instructing display of the life log information corresponding to the time slots.

[Supplementary Note 9]

The life log management device according to any one of Supplementary Notes 1 to 8,

wherein the image retrieval unit is configured to determine, based on user information with which past positions of the target user are identified, the installation camera images from which the objective image is to be retrieved.

[Supplementary Note 10]

The life log management device according to any one of Supplementary Notes 1 to 9, further comprising

a sound control unit configured to output, by a sound output device, sound recorded at the same time as the objective image.

[Supplementary Note 11]

A control method executed by a computer, the control method comprising:

retrieving an objective image in which a target user is photographed from a database of installation camera images generated by a camera installed in a public place;

generating life log information based on the objective image; and

displaying the life log information on a display device.

[Supplementary Note 12]

A storage medium storing a program executed by a computer, the program causing the computer to function as:

an image retrieval unit configured to retrieve an objective image in which a target user is photographed from a database of installation camera images generated by a camera installed in a public place;

an objective image generation unit configured to generate life log information based on the objective image; and

a display control unit configured to display the life log information on a display device.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### INDUSTRIAL APPLICABILITY

The present invention can be utilized in systems for browsing life logs. It can also be utilized for overcoming fear, etc., by reconfirming the past self-situation for the purpose of overcoming the trauma or rehabilitation. In this case, it is also conceivable to utilize it for overcoming fear by replacing the past fear experience by minutely modifying the past image. For example, if there is a trauma based on an experience that it was about to collide with a vehicle, such an aspect is contemplated that an image in which the position of the vehicle is intentionally shifted is provided.

### DESCRIPTION OF REFERENCE NUMERALS

1, 1A Life log management device
2 Storage device
4 User terminal
5 Installation camera
6 Input device
7 Display device
8 Camera
20 Landscape DB
21 Three dimensional model DB
22 Installation camera image DB
23 User information
24 Life log DB
100 Life log management system

What is claimed is:

1. A life log management device comprising:
at least one memory configured to store instructions; and
at least one processor configured to execute the instructions to
retrieve an objective image in which a target user is photographed from a database of installation camera images generated by a camera installed in a public place; and
display life log information based on the objective image on a display device.

2. The life log management device according to claim 1,
wherein the at least one processor is configured to execute the instructions to display, on the display device, the life log information,
the life log information including at least one of:
the objective image; or
a subjective image based on a viewpoint and a line-of-sight direction of the target user shown in the objective image.

3. The life log management device according to claim 2,
wherein the at least one processor is configured to further execute the instructions to generate the subjective image using a landscape image searched for from a database of landscape images representing a landscape in the public place,
the landscape image being searched for based on the viewpoint and the line-of-sight direction.

4. The life log management device according to claim 3,
wherein the at least one processor is configured to execute the instructions to generate the subjective image obtained by superimposing
an image representing a person captured in the objective image other than the target user and
an image representing an object captured in the objective image other than human
on a background image generated based on the landscape image.

5. The life log management device according to claim 2,
wherein the at least one processor is configured to execute the instructions to simultaneously play back, on the display device,
an objective video obtained by the objective image in time series and
a subjective video obtained by the subjective image in time series in a same time slot as the objective image in time series.

6. The life log management device according to claim 3,
wherein the display device is a head-mounted display, and
wherein the at least one processor is configured to execute the instructions to change,
based on line-of-sight information regarding the target user detected by the head-mounted display,
the line-of-sight direction to be used as a reference for generating the subjective image.

7. The life log management device according to claim 1,
wherein the at least one processor is configured to execute the instructions to retrieve the objective image from the database of the installation camera images based on an authentication image for authenticating the target user.

8. The life log management device according to claim 1,
wherein the at least one processor is configured to execute the instructions to display, on the display device, a list of time slots, on a specified date, in which the objective image is present together with a user interface for instructing display of the life log information corresponding to the time slots.

9. The life log management device according to claim 1,
wherein the at least one processor is configured to execute the instructions to determine, based on user information with which past positions of the target user are identified, the installation camera images from which the objective image is to be retrieved.

10. The life log management device according to claim 1,
wherein the at least one processor is configured to further execute the instructions to output, by a sound output device, sound recorded at the same time as the objective image.

11. A control method executed by a computer, the control method comprising:
retrieving an objective image in which a target user is photographed from a database of installation camera images generated by a camera installed in a public place;
generating life log information based on the objective image; and
displaying the life log information on a display device.

12. A non-transitory computer readable storage medium storing a program executed by a computer, the program causing the computer to:
retrieve an objective image in which a target user is photographed from a database of installation camera images generated by a camera installed in a public place;
generate life log information based on the objective image; and
display the life log information on a display device.
